(19) United States
(12) Patent Application Publication
(10) Pub. No.: US 2026/0070215 A1
(43) Pub. Date: Mar. 12, 2026

(54) Emotion Aware Cognitive Operating System Using Multi Agent Prediction, Cycle hit Scoring and Intuitive Knowledge Calibration

(71) Applicant: DARIO CHANG, doral, FL (US)

(72) Inventor: DARIO CHANG, doral, FL (US)

(21) Appl. No.: 19/313,903

(22) Filed: Aug. 29, 2025

(51) Int. Cl. B25J 9/16; B25J 13/08

(52) U.S. Cl. CPC B25J 9/163; B25J 9/1605; B25J 9/161; B25J 9/1653; B25J 13/08

(57) ABSTRACT

An emotion-aware computing operating system integrates multimodal sensory inputs, stratified memory, cyclehit scoring, and history score values to predict user tasks, orchestrate autonomous cognitive agents, and adapt interface outputs in real time. A prediction module applies cyclehit scoring derived from historical task cycles and weighted history score values to forecast workflows.

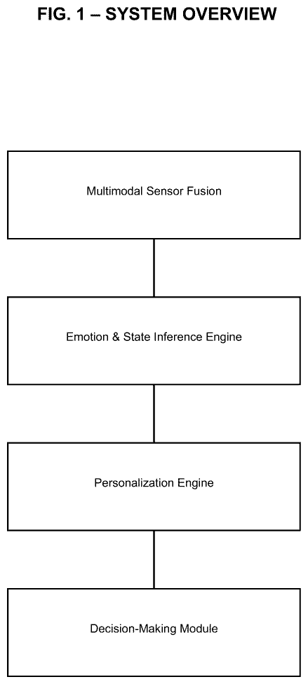

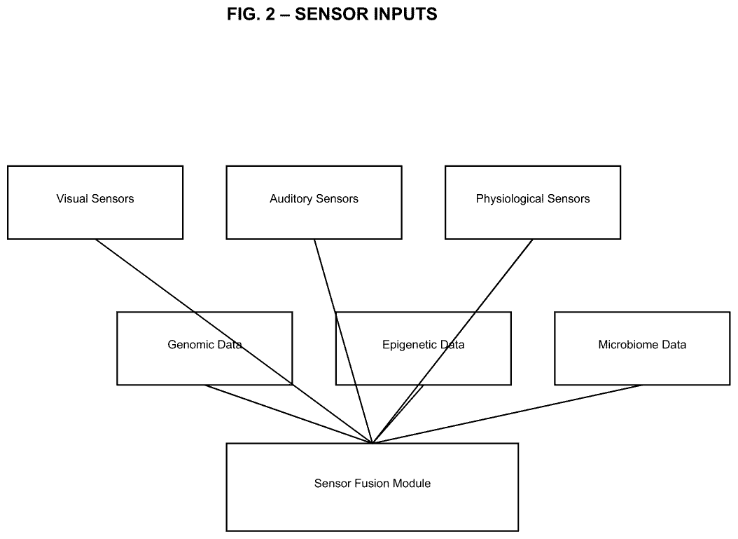

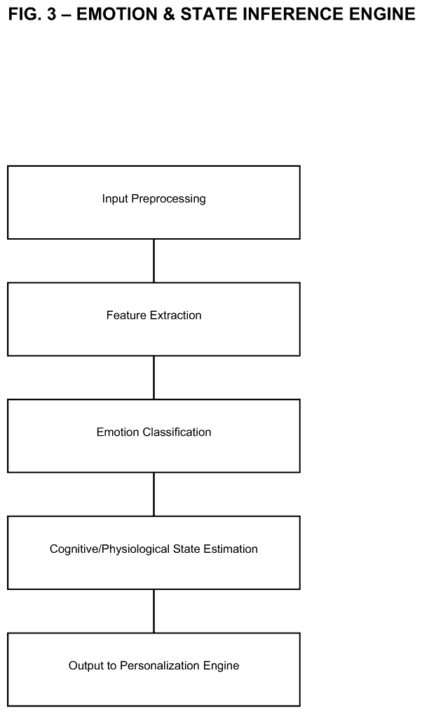

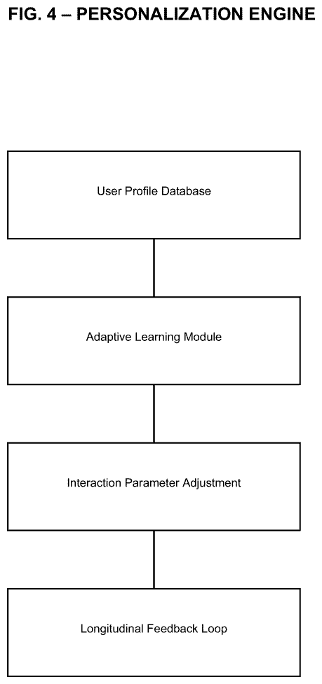

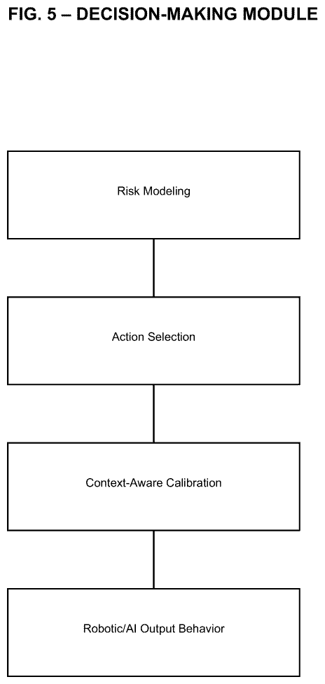

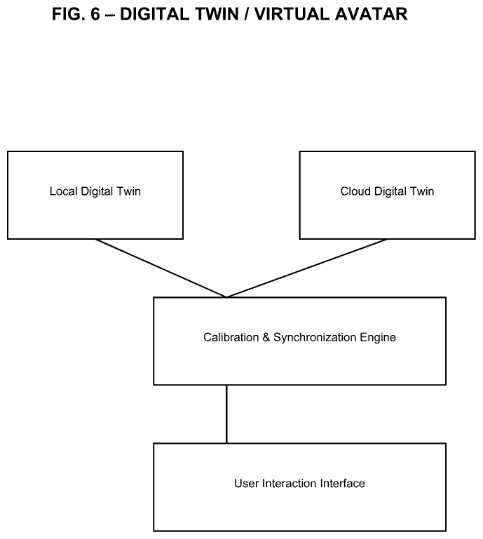

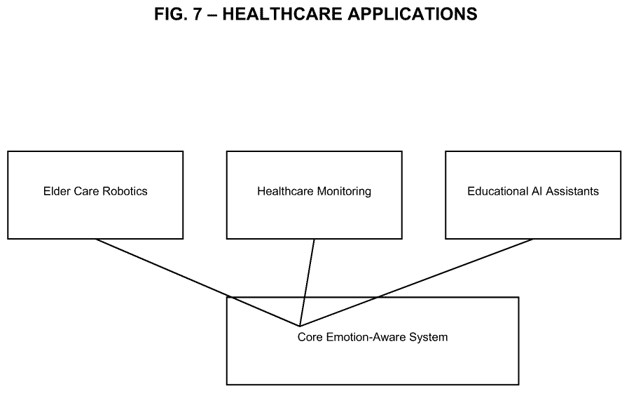

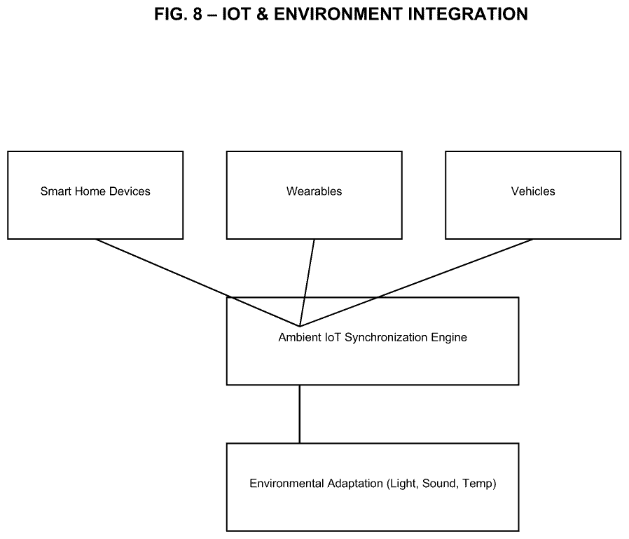

An orchestration kernel selects and coordinates agents, redistributes subtasks, and negotiates dynamically under cognitive load. A stratified memory fabric maintains ephemeral, situational, and long-term user models for personalization. An adaptive interface layer adjusts informational density and tool availability based on inferred user state. A certification and licensing API enforces agent onboarding, compliance, and monetization policies, requiring registration of performance metrics prior to integration. Embodiments include software, cloud, edge, and robotic platforms, enabling monetizable deployment across healthcare, finance, education, enterprise, and ambient device ecosystems.

### FIELD OF THE INVENTION

The present invention relates to artificial intelligence and operating systems, and more particularly to multi-agent architectures that replace discrete applications with intention-driven orchestration, predictive task execution, and stratified personalization. The system integrates multimodal sensory data, cyclehit scoring, and history score values to calibrate user intentions and deliver optimal outcomes in autonomous AI prediction and intuitive knowledge fields.

### BACKGROUND

Conventional computing platforms rely on siloed applications and manual navigation. These systems fail to interpret abstract user intentions, predict tasks based on historical cycles and emotional context, orchestrate multiple agents dynamically under cognitive load, adapt interfaces in real time to emotional state, and maintain stratified memory for personalization.

Existing personalization approaches are limited to demographic or behavioral profiling and do not incorporate deeper biological, genomic, or longitudinal scoring mechanisms. There is a need for an operating system that integrates multimodal signals, cyclehit scoring, and history score values to calibrate intentions and deliver optimal outcomes.

### SUMMARY OF THE INVENTION

The invention provides a computing operating system that:
Interprets human emotional and cognitive states using multimodal sensory integration;
Refines personalization with adaptive machine learning informed by permissible biological and behavioral data under user consent;
Generates task forecasts using cyclehit scoring and history score values;
Orchestrates agent workflows via an orchestration kernel that negotiates under cognitive load;
Exposes a certification and licensing API to enforce onboarding, compliance, and monetization.

### DEFINITIONS

Cyclehit scoring: A mechanism that logs agent task cycles (intention→execution→feedback) and records a “hit” when the agent's output aligns with a user-verified outcome or positive feedback. This formalizes and extends the personalization cycle models disclosed in US2004/0133469A1.
History score values: Weighted aggregates of past cycle outcomes, contextual metadata, and user satisfaction metrics used to bias future predictions and agent selection.
Stratified memory fabric: Tiered storage of interaction data across ephemeral, situational, and long-term layers to support real-time context and longitudinal personalization.
Orchestration kernel: Runtime component that selects agents, computes weighted relevance scores, negotiates subtasks, enforces load thresholds, and issues execution commands.
Certification and licensing API: Interface requiring agent registration metadata, performance metrics (including cyclehit logs), and compliance attestations; enforces onboarding checks and issues orchestration tokens or privileges based on compliance and subscription tiers.

### DETAILED DESCRIPTION

### Sensors and Inputs

Sensors include cameras, microphones, wearable biometric devices (e.g., smartwatches, rings), and optional biochemical analyzers where permitted by law and user consent. Input streams include voice, text, gesture, gaze, motion, heart rate variability, and other physiological signals. Edge processing and federated learning are preferred to reduce centralized exposure of sensitive data.

### Emotion Inference Engine

The emotion inference engine fuses multimodal signals to produce dimensional emotional profiles and confidence scores. Example processing pipelines include convolutional neural networks for visual features, recurrent or transformer models for audio/text, and temporal filters for physiological signals. Fusion layers combine modality outputs into an emotional confidence vector used by downstream modules.

### Prediction Module and Cyclehit Scoring

The prediction module computes cyclehit scores and history score values to forecast tasks and prioritize agents.

### Formalization:

Represent a cycle as a tuple C=(I, A, F) where I is an intention token, A is agent action metadata, and F is feedback (binary or scalar).
Compute an agent cyclehit score over n cycles as a recency-weighted average: [\text{cyclehit}a=\frac{\sum{i=1}\hat{ }{n}w_i \cdot h_i}{\sum_{i=1}\hat{ }{n}w_i}] where h_i∈{0,1} indicates hit/miss and w_i are recency weights.
Compute a history score value as a combination of cyclehit and contextual weights: [\text{history}_a=\lambda_1\cdot\text{cyclehit}_a+\lambda_2\cdot \text{contextual_weight}]

These scores are stored in the stratified memory fabric and used to bias orchestration decisions.

### Orchestration Kernel

The orchestration kernel selects agents and distributes subtasks using a scoring function: [\text{score}(a,t)−\alpha\cdot\text{cyclehit}_a+\beta\cdot\text{history}_a+\gamma\cdot\text{relevance}(a,t)−\delta\cdot\text{load}_a] where (\alpha, \beta, \gamma, \delta) are tunable parameters. The kernel supports negotiation protocols (e.g., auction, consensus), load thresholds, and dynamic redistribution when cognitive load or agent overload is detected.

### Stratified Memory Fabric

Memory tiers include ephemeral context for immediate interactions, situational patterns for session-level adaptation, and long-term preferences for personalization. Cyclehit logs and history score values are stored across tiers with retention policies and encryption. The fabric supports fast lookup for real-time orchestration and aggregated analytics for long-term model updates.

### Adaptive Interface Layer

The adaptive interface monitors cognitive load indicators and adjusts information density, tool availability, and presentation modalities. Example heuristics: reduce displayed items when cognitive load exceeds a threshold; expand toolset when high focus is inferred. The interface supports multimodal outputs (visual, auditory, haptic) and latency budgets for real-time responsiveness.

### Certification and Licensing Api

The API requires agent registration metadata, performance metrics (including cyclehit logs), and compliance attestations. Example endpoints include /registerAgent, /submitMetrics, /requestOrchestrationToken, and /queryAuditLog. Agents failing onboarding checks are sandboxed or denied orchestration privileges. The API supports subscription tiers, role-based privileges, and audit trails recorded in immutable ledgers where required.

### Robotic and Other Embodiments

Robotic embodiments include locomotion and manipulation components, actuators with self-calibration loops, and a personalization engine that adapts gesture, voice, and pacing based on historical interaction scores. The orchestration kernel can generate robot control commands derived from prioritized tasks and safety constraints. Software-only and ambient embodiments operate as cloud services, local agents, or IoT integrations.

### Privacy, Consent, and Compliance

Biological data integration is optional and subject to explicit user consent and applicable laws. Preferred implementations use edge processing, federated learning, encryption, and differential privacy techniques. The specification emphasizes opt-in controls, auditability, and data minimization.

### Examiner Guidance and Enablement Notes

This specification anticipates and addresses potential enablement and definiteness concerns:
All scoring mechanisms (cyclehit, history) are formally defined with mathematical clarity.
The orchestration kernel's decision logic is expressed via tunable scoring functions.
The stratified memory fabric is described with sufficient detail to enable implementation.
The certification API is disclosed with example endpoints and compliance logic.
Privacy and consent mechanisms are described in accordance with current best practices.
The invention is fully enabled for software, cloud, edge, and robotic embodiments.

### Continuation-in-Part Bridge

Applicant anticipates future enhancements involving:
Biochemical and genomic personalization modules;
Physics-informed reasoning layers;
Gesture shadow detection and solar-powered tactile interfaces;
Quantum-inspired orchestration optimization;
Integration with brain-computer interfaces (BCI).

These enhancements may be pursued in one or more continuation-in-part (CIP) applications. This specification is intended to serve as a foundational disclosure to which such future claims may be connected, where supported by new matter.

### Closing Statement

It will be appreciated by those skilled in the art that modifications, substitutions, and variations can be made without departing from the spirit and scope of the invention as defined in the appended claims. The examples and numerical values provided are illustrative and not limiting.

1. A computing operating system comprising:
a plurality of autonomous cognitive agents configured to interpret user intention, predict tasks, resolve workflows, and adjust interface parameters;
a prediction module applying cyclehit scoring and history score values to forecast tasks;
an orchestration kernel configured to select, activate, and coordinate agents, redistribute subtasks, and negotiate dynamically under cognitive load;
a stratified memory fabric storing user models updated over time based on prior interactions, prediction scores, and agent outputs; and
an adaptive interface layer configured to receive multimodal inputs and provide output presentations adapted in real time;
wherein a certification and licensing API enforces orchestration policies and requires third-party agents to register performance metrics prior to integration, thereby enabling monetizable deployment across vertical domains.

2. A computer-implemented method comprising:
receiving multimodal input from a user;
determining user intention and user state;
generating task forecasts using a prediction module that applies cyclehit scoring and history score values derived from prior task cycles and feedback;
selecting a subset of agents based on the generated task forecasts and the determined user state;
coordinating execution of the selected agents such that subtasks are distributed, conflicts are resolved, and complexity is adjusted according to weighted scoring functions; and
providing to the user, via an adaptive interface, a structured output comprising at least one of: a recommended action plan, an organized information set, a task sequence, or a synthesized insight.

3. A non-transitory computer-readable medium storing instructions that, when executed by one or more processors, cause the processors to perform operations comprising:
receiving multimodal user input;
applying cyclehit scoring algorithms and history score values in a prediction module to prioritize and forecast tasks;
invoking an orchestration kernel to select and coordinate autonomous cognitive agents to execute subtasks; and
generating adaptive interface outputs responsive to agent outputs and user state.

4. The system of claim 1, wherein the orchestration kernel is configured to generate robot control commands for a robotic embodiment comprising locomotion and manipulation components, processors executing a plurality of autonomous cognitive agents, and a personalization engine configured to adapt gesture, voice, and pacing parameters based on historical interaction scores.

5. The system of claim 1, wherein the certification and licensing API requires third-party agents to register cyclehit performance metrics before integration.

6. The system of claim 1, wherein orchestration policies are enforced through licensing agreements tied to agent compliance with prediction scoring.

7. The system of claim 1, wherein audit logs of orchestration outputs are recorded in immutable ledgers for compliance and monetization.

8. The system of claim 1, wherein monetization includes subscription tiers and role-based orchestration privileges for agents.

9. The system of claim 1, wherein the orchestration kernel enforces agent onboarding policies including role validation, performance thresholds, and compliance with prediction scoring protocols.

10. The system of claim 1, wherein the prediction module applies cyclehit scoring derived from historical task cycles and wherein a cyclehit is recorded when an agent's output aligns with a user-verified outcome.

11. The system of claim 1, wherein task prioritization is weighted by history score values that combine cyclehit scores with contextual metadata including task criticality and emotional context.

12. The system of claim 1, wherein the orchestration kernel negotiates among agents using weighted scoring functions based on relevance, urgency, and cognitive load.

13. The system of claim 1, wherein the stratified memory fabric comprises ephemeral context, situational patterns, and long-term preferences and stores cyclehit logs across the tiers.

14. The system of claim 1, wherein the adaptive interface reduces informational density when overload is detected and expands tools when high focus is inferred.

15. The system of claim 1, wherein multimodal inputs include voice, text, gesture, gaze, physiological signals, and temporal usage patterns.

16. The system of claim 1, wherein orchestration is applied to healthcare workflows including patient monitoring, therapy augmentation, and predictive alerts.

17. The system of claim 1, wherein orchestration is applied to financial workflows including predictive compliance, transaction monitoring, and risk scoring.

18. The system of claim 1, wherein orchestration is applied to educational workflows including adaptive tutoring and cognitive load balancing.

19. The system of claim 1, wherein orchestration is applied to enterprise workflows including customer support, search, and collaboration.

20. The system of claim 1, wherein emotional calibration is synchronized across ambient devices including smart home hubs, vehicles, and wearables.
